(19) United States
(12) Patent Application Publication
(10) Pub. No.: US 2021/0300548 A1
(43) Pub. Date: Sep. 30, 2021

(54) Handsfree Autonomous Umbrella Assembly

(71) Applicants: Quiana Kinzer, Antioch, TN (US); Sammie Clark, Antioch, GA (US); Donna Bohannon, Antioch, TN (US); Nakayla Pinkston, Antioch, GA (US); Diantheia Clark, Antioch, GA (US)

(72) Inventors: Quiana Kinzer, Antioch, TN (US); Sammie Clark, Antioch, GA (US); Donna Bohannon, Antioch, TN (US); Nakayla Pinkston, Antioch, GA (US); Diantheia Clark, Antioch, GA (US)

(21) Appl. No.: 16/828,317

(22) Filed: Mar. 24, 2020

(51) Int. Cl. B64C 39/02; A45B 25/14

(52) U.S. Cl. CPC B64C 39/024; A45B 25/143; B64C 2201/027; B64C 2201/141; B64C 2201/12; B64C 2201/146; B64C 2201/042; B64C 2201/108

(57) ABSTRACT

A handsfree autonomous umbrella assembly for shielding a user from the elements includes an umbrella and a drone module. The umbrella comprises a shaft and a frame, which has a canopy engaged thereto. The frame is engaged to a first end of the shaft and can be selectively positioned in a collapsed configuration and a deployed configuration, wherein the frame has a concave face and a convex face. The shaft extends from the concave face. The drone module is engaged to the shaft and receives commands to selectively provide directional thrust. A control unit transmits commands to the drone module, enabling the drone module to track the control unit. The control unit is positioned to command the drone module to maintain a relative position above a user who possesses the control unit. The canopy thus shields the user from the elements.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to umbrella assemblies and more particularly pertains to a new umbrella assembly for shielding a user from the elements.

### (2) Description of Related Art Including Information Disclosed Under 37 CFR 1.97 and 1.98

The prior art relates to umbrella assemblies and may comprise a helium filled umbrella shaped bladder having a propeller positioned on a concave surface thereof for directional stabilization. Related prior assemblies may comprise one or more drones engaged to a planar panel and being operable for positioning between a user and the sun.

### BRIEF SUMMARY OF THE INVENTION

An embodiment of the disclosure meets the needs presented above by generally comprising an umbrella and a drone module. The umbrella comprises a shaft and a frame, which has a canopy engaged thereto. The frame is engaged to a first end of the shaft and is configured to be selectively positioned in a collapsed configuration and a deployed configuration, wherein the frame has a concave face and a convex face. The shaft extends from the concave face. The drone module is engaged to the shaft and is configured to receive commands and to selectively provide directional thrust. A control unit is configured to transmit commands to the drone module, enabling the drone module to track the control unit. The control unit is positioned to command the drone module to maintain a relative position above a user who possesses the control unit. The canopy thus is configured to shield the user from the elements.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a handsfree autonomous umbrella assembly according to an embodiment of the disclosure.

FIG. 2 is a top isometric perspective view of an embodiment of the disclosure.

FIG. 3 is a side cut-away view of an embodiment of the disclosure.

FIG. 4 is a top view of an embodiment of the disclosure.

FIG. 5 is a bottom view of an embodiment of the disclosure.

FIG. 6 is a side cut-away view of an embodiment of the disclosure.

FIG. 7 is a side view of an embodiment of the disclosure in a collapsed configuration.

### DETAILED DESCRIPTION OF THE INVENTION

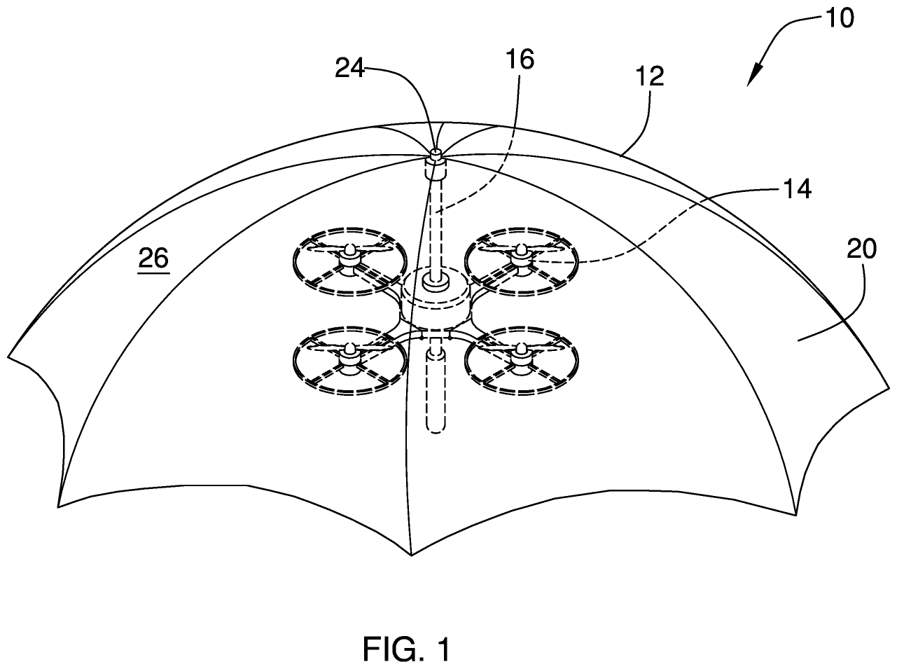

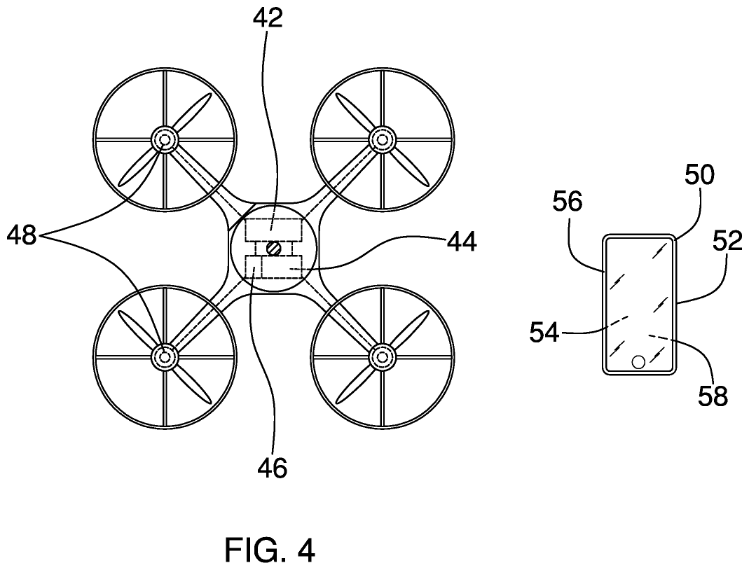

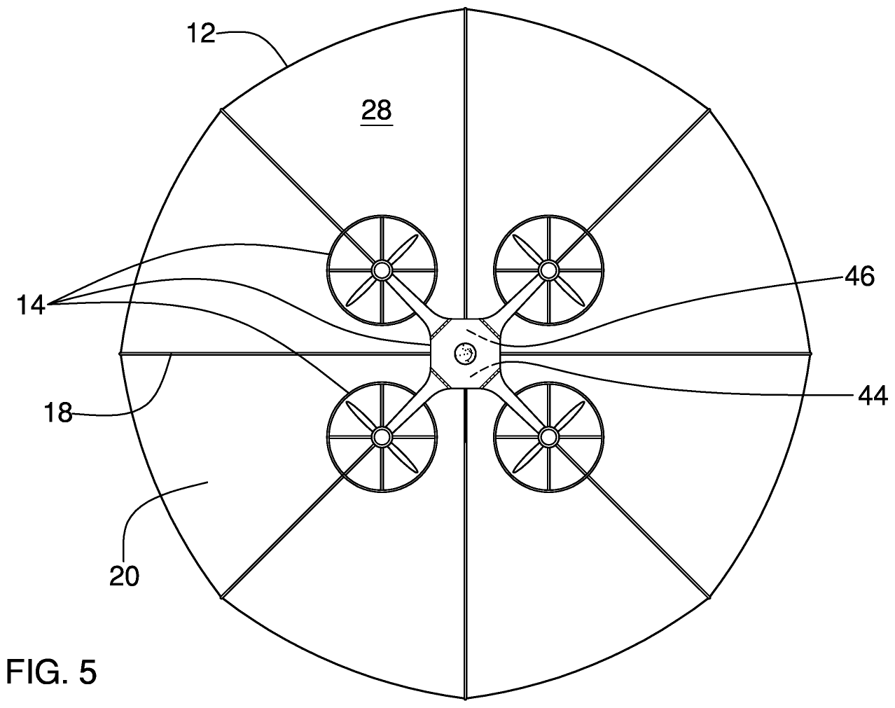

With reference now to the drawings, and in particular to FIGS. 1 through 7 thereof, a new umbrella assembly embodying the principles and concepts of an embodiment of the disclosure and generally designated by the reference numeral 10 will be described.

As best illustrated in FIGS. 1 through 7, the handsfree autonomous umbrella assembly 10 generally comprises an umbrella 12 and a drone module 14. The umbrella 12 comprises a shaft 16 and a frame 18, which has a canopy 20 engaged thereto. The shaft 16 may comprise a plurality of nested sections 22 so that the shaft 16 is selectively extensible, a feature that is known to those skilled in the art of umbrellas.

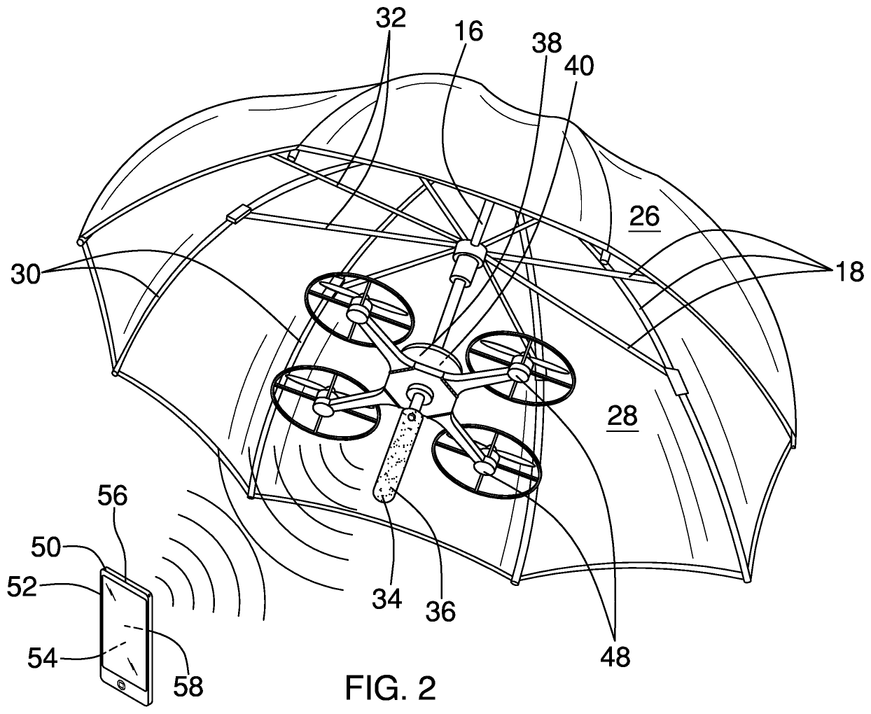

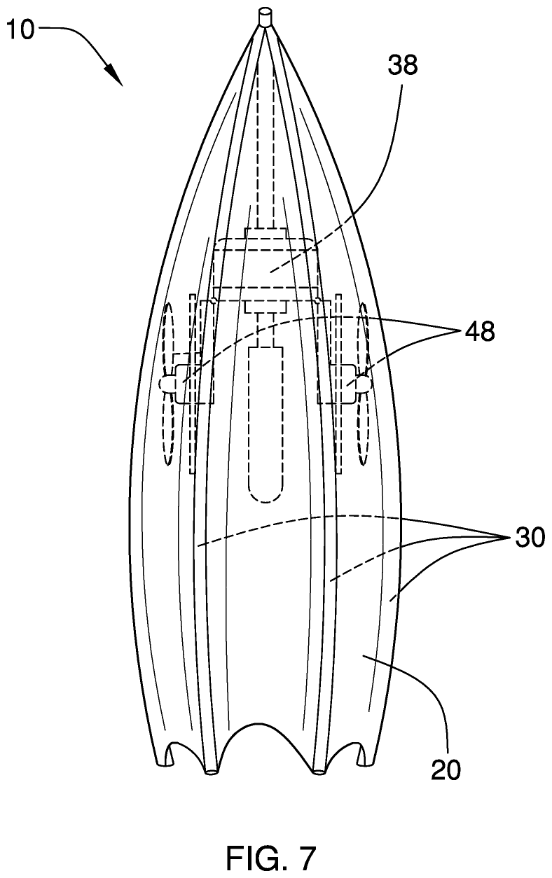

The frame 18 is engaged to a first end 24 of the shaft 16 and is configured to be selectively positioned in a collapsed configuration, as shown in FIG. 7, and a deployed configuration, as shown in FIG. 2. In the deployed configuration, the frame 18 has a convex face 26 and a concave face 28, from which the shaft 16 extends. The frame 18 comprises a plurality of ribs 30 and a plurality of stretchers 32. As shown in FIG. 2, each rib 30 is coupled and extends from the shaft 16 proximate to the first end 24. Each stretcher 32 is coupled to the shaft 16 and is engaged to an associated rib 30 to stabilize the frame 18 in the deployed configuration.

A grip 34 is engaged to the shaft 16 proximate to a second end 36 thereof. The grip 34 is configured to be grasped in a hand of a user, enabling the user to manipulate the umbrella 12. The grip 34 comprises at least one of silicone, rubber, and elastomer.

The drone module 14 is engaged to the shaft 16 and is configured to receive commands and to selectively provide directional thrust. The drone module 14 comprises a housing 38, which is engaged to the shaft 16 so that the shaft 16 extends axially therefrom. The housing 38 defines an interior space 40 in which a battery 42 is positioned. The battery 42 may be rechargeable. A flight control module 44 and a transceiver 46 are coupled to the housing 38 and are positioned in the interior space 40. The flight control module 44 is operationally engaged to the battery 42 and the transceiver 46. The flight control module 44 also may be operationally coupled to the frame 18, such that the frame 18 is positioned to actuate the flight control module upon being positioned in the deployed configuration.

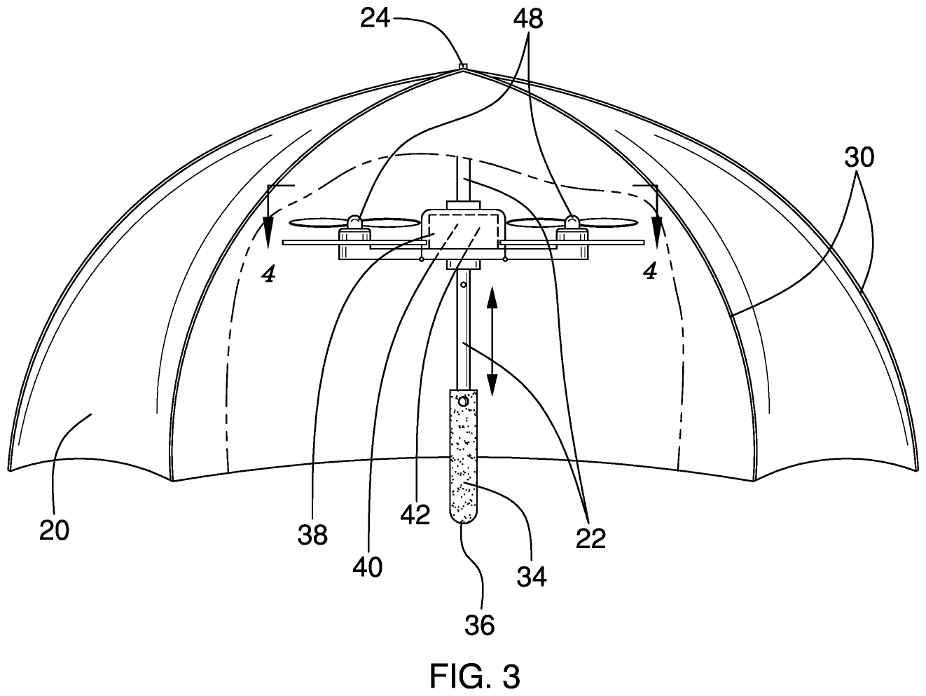

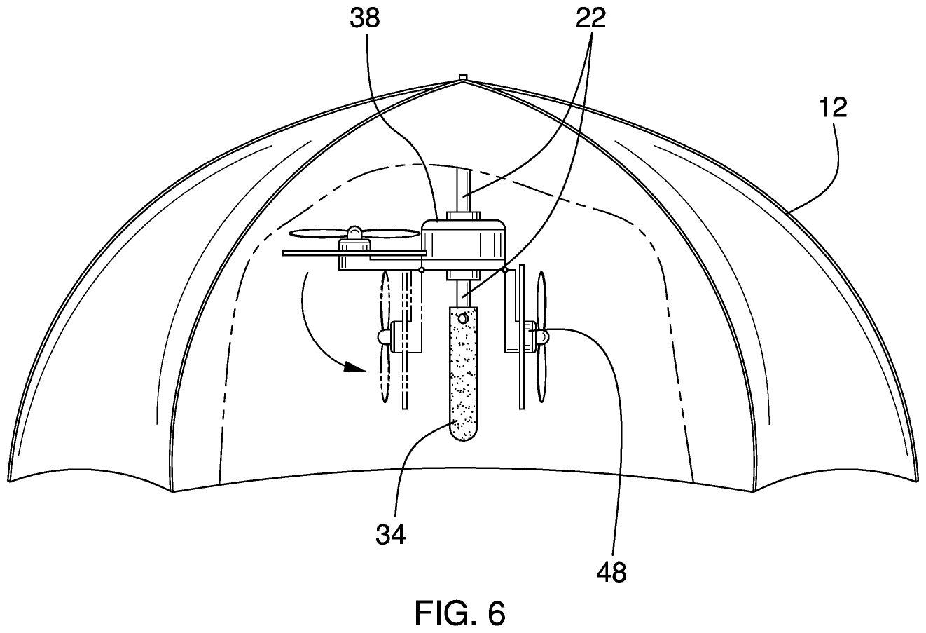

A plurality of rotors 48 is operationally engaged to the flight control module 44. Each rotor 48 is hingedly engaged to the housing 38. The plurality of rotors 48 is selectively positionable in a collapsed orientation, as shown in FIG. 7, and a deployed orientation, as shown in FIG. 2, which correlate with the collapsed configuration and deployed configuration of the frame 18, respectively. In the collapsed orientation, each rotor 48 is positioned proximate to the shaft 16, as shown in FIG. 6. In the deployed orientation, the rotors 48 are substantially coplanar, as shown in FIG. 3. The plurality of rotors 48 may comprise four rotors 48, as shown in FIG. 2, or other number of rotors 48, such as six rotors 48 and eight rotors 48.

The assembly 10 also comprises a control unit 50, which is configured to transmit commands to the drone module 14, enabling the drone module 14 to track the control unit 50. The control unit 50 is positioned to command the drone module 14 to maintain a relative position above a user who possesses the control unit 50. The canopy 20 thus is configured to shield the user from the elements.

The control unit 50 comprises an electronic device 52, which comprises a transmitter 54 positioned to wirelessly communicate the commands from the control unit 50 to the flight control module 44 via the transceiver 46. The electronic device 52 may comprise a smartphone 56, as shown in FIG. 2, or a purpose built unit. Programming code 58 positioned on the electronic device 52 enables the user to direct the drone module 14 to maintain the relative position above the user. The programming code 58 also may enable the user to actuate the drone module 14.

In use, the frame 18 and the plurality of rotors 48 are positioned in the deployed configuration and deployed orientation, respectively, which actuates the flight control module 44. The user then use the smartphone 56 to set the position of the umbrella 12 above their head. The drone module 14 maintains the relative position above the user as the user moves, thus shielding the user from the elements and leaving the user's hands free to perform other tasks.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A handsfree autonomous umbrella assembly comprising:
an umbrella comprising:
a shaft,
a frame engaged to a first end of the shaft and being configured for selectively positioning in a collapsed configuration and a deployed configuration, wherein the frame has a concave face, from which the shaft extends, and a convex face;
a canopy engaged to the frame;
a drone module engaged to the shaft and being configured for receiving commands and for selectively providing directional thrust; and
a control unit configured for transmitting commands to the drone module enabling the drone module for tracking the control unit, such that the control unit is positioned for commanding the drone module for maintaining a relative position above a user possessing the control unit, wherein the canopy is configured for shielding the user from the elements.

2. The handsfree autonomous umbrella assembly of claim 1, wherein the frame comprises:
a plurality of ribs, each rib being coupled and extending from the shaft proximate to the first end; and
a plurality of stretchers, each stretcher being coupled to the shaft and engaged to an associated rib for stabilizing the frame in the deployed configuration.

3. The handsfree autonomous umbrella assembly of claim 1, wherein the shaft comprises a plurality of nested sections such that the shaft is selectively extensible.

4. The handsfree autonomous umbrella assembly of claim 1, further including a grip engaged to the shaft proximate to a second end of the shaft, wherein the grip is configured for grasping in a hand of the user enabling the user to manipulate the umbrella.

5. The handsfree autonomous umbrella assembly of claim 4, wherein the grip comprises at least one of silicone, rubber, and elastomer.

6. The handsfree autonomous umbrella assembly of claim 1, wherein the drone module comprises:
a housing engaged to the shaft such that the shaft extends axially therefrom, the housing defining an interior space;
a battery positioned in the interior space;
a flight control module coupled to the housing and positioned in the interior space, the flight control module being operationally engaged to the battery;
a transceiver coupled to the housing and positioned in the interior space, the transceiver being operationally engaged to the flight control module; and
a plurality of rotors operationally engaged to the flight control module, each rotor being hingedly engaged to the housing, such that the plurality of rotors is selectively positionable in a collapsed orientation, wherein each rotor is positioned proximate to the shaft, and a deployed orientation, wherein the rotors are substantially coplanar.

7. The handsfree autonomous umbrella assembly of claim 6, wherein the plurality of rotors comprises four rotors.

8. The handsfree autonomous umbrella assembly of claim 6, wherein the battery is rechargeable.

9. The handsfree autonomous umbrella assembly of claim 6, wherein the control unit comprises:
an electronic device comprising a transmitter, such that the transmitter is positioned for wirelessly communicating the commands from the control unit to the flight control module via the transceiver; and
programming code positioned on the electronic device enabling the user for directing the drone module for maintaining the relative position above the user.

10. The handsfree autonomous umbrella assembly of claim 9, wherein the electronic device comprises a smartphone.

11. The handsfree autonomous umbrella assembly of claim 9, wherein the programming code enables the user to actuate the drone module.

12. The handsfree autonomous umbrella assembly of claim 6, wherein the flight control module is operationally coupled to the frame, such that the frame is positioned for actuating the flight control module upon being positioned in the deployed configuration.

13. A handsfree autonomous umbrella assembly comprising:
an umbrella comprising:
a shaft, the shaft comprising a plurality of nested sections such that the shaft is selectively extensible,
a frame engaged to a first end of the shaft and being configured for selectively positioning in a collapsed configuration and a deployed configuration, wherein the frame has a concave face, from which the shaft extends, and a convex face, the frame comprising:
a plurality of ribs, each rib being coupled and extending from the shaft proximate to the first end, and
a plurality of stretchers, each stretcher being coupled to the shaft and engaged to an associated rib for stabilizing the frame in the deployed configuration,
a canopy engaged to the frame, and
a grip engaged to the shaft proximate to a second end of the shaft, wherein the grip is configured for grasping in a hand of a user enabling the user to manipulate the umbrella, the grip comprising at least one of silicone, rubber, and elastomer;
a drone module engaged to the shaft and being configured for receiving commands and for selectively providing directional thrust, the drone module comprising:
a housing engaged to the shaft such that the shaft extends axially therefrom, the housing defining an interior space,
a battery positioned in the interior space, the battery being rechargeable,
a flight control module coupled to the housing and positioned in the interior space, the flight control module being operationally engaged to the battery, the flight control module being operationally coupled to the frame, such that the frame is positioned for actuating the flight control module upon being positioned in the deployed configuration,
a transceiver coupled to the housing and positioned in the interior space, the transceiver being operationally engaged to the flight control module, and
a plurality of rotors operationally engaged to the flight control module, each rotor being hingedly engaged to the housing, such that the plurality of rotors is selectively positionable in a collapsed orientation, wherein each rotor is positioned proximate to the shaft, and a deployed orientation, wherein the rotors are substantially coplanar, the plurality of rotors comprising four rotors; and
a control unit configured for transmitting commands to the drone module enabling the drone module for tracking the control unit, such that the control unit is positioned for commanding the drone module for maintaining a relative position above a user possessing the control unit, wherein the canopy is configured for shielding the user from the elements, the control unit comprising:
an electronic device comprising a transmitter, such that the transmitter is positioned for wirelessly communicating the commands from the control unit to the flight control module via the transceiver, the electronic device comprising a smartphone, and
programming code positioned on the electronic device enabling the user for directing the drone module for maintaining the relative position above the user and for actuating the drone module.
